(19) United States
(12) Patent Application Publication
(10) Pub. No.: US 2017/0166372 A1
(43) Pub. Date: Jun. 15, 2017

(54) RECYCLABLE LEAK RESISTANT CORRUGATED BOX

(71) Applicant: INTERSTATE CORRPACK LLC, Cambridge, MD (US)

(72) Inventor: PETER A. BUGAS, Salisbury, MD (US)

(73) Assignee: INTERSTATE CORRPACK LLC, Cambridge, MD (US)

(21) Appl. No.: 15/374,198

(22) Filed: Dec. 9, 2016

Related U.S. Application Data
(60) Provisional application No. 62/265,162, filed on Dec. 9, 2015.

(51) Int. Cl. B65D 65/46; B65D 5/42; B65D 5/22; C09D 5/02; B65D 5/64; A01K 39/01; C09D 125/08; B65D 5/56; B65D 5/44

(52) U.S. Cl. CPC B65D 65/466; B65D 5/563; B65D 5/4279; B65D 5/22; B65D 5/4266; B65D 5/443; B65D 5/64; A01K 39/01; C09D 125/08; C09D 5/022; B65D 2565/385

(57) ABSTRACT

A repulpable moisture resistant poultry box having a composite corrugated structure with a fluted medium formed of a top backing board secured to one side of the fluted medium and a bottom backing board secured to the other side of the fluted medium, the box being impregnated with a hydrogenated triglyceride and coated with an acrylic styrene copolymer. The box has a bottom panel, side panels integral with the bottom panel and end panel assemblies integral with the bottom panel. The end panel assemblies comprise an outer end panel and a plurality of reinforcing end panels positioned adjacent said outer end panel. Each of the panels in the end panel assembly defines a cut out which is aligned with each other cutout panel in the end panel assembly to present a single uniformly configured cutout. The reinforcing end panels define a tab cut adjacent the outer end panel and each bottom corner of the bottom end panel forming a tab to seal the bottom corners of the box.

### RELATED APPLICATIONS

This is a utility patent application claiming priority and benefit from U.S. Provisional Patent Application No. 62/265,162, filed Dec. 9, 2015.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### FIELD OF THE INVENTION

The present invention generally relates to moisture resistant and water proof paper products including linerboard and corrugated board. Particularly, this invention relates to moisture resistant corrugated paper boxes used primarily in the poultry industry that are waterproofed and can be repulped and recycled to be part of the feedstock for corrugated paper products that minimizes environmental concerns.

### BACKGROUND OF THE INVENTION

In the manufacture of paper and paperboard and of products made from same, petroleum derived paraffin waxes and synthetic polymers have been used for many years as moisture retardants, water repellents, oil repellents, stiffeners, strengtheners, and release agents. Besides paraffin, the material used most often in such products is polyethylene. However, other widely used polymers in the field include polymerized acrylics, vinyls, styrenes, ethylenes and copolymers or hetero-polymers of these monomers.

The paper and paperboard to which traditional wax materials are applied is difficult and often impossible to repulp and recycle in standard paper mill processes because the petroleum derived polymers and, particularly, the petroleum waxes are non-biodegradable in mill white waters (circulated process waters) and discharge effluents. Furthermore, the residue of the petroleum waxes that is not removed from pulp fibers during the repulping and recycling processes causes severe problems due to buildup that occurs on the screens and felts used during the process of forming and making the paper or paperboard sheet. In addition, paper and paperboard coated or impregnated with petroleum waxes resist biodegradation and composting when disposed of in landfills and other waste disposal systems. Paper and paperboard coated or impregnated with traditional synthetic polymers and hetero-polymers are also difficult and often impossible to repulp and recycle owing to their resistance to separation from the fiber in the standard repulping processes resulting in significant fiber losses in efforts to repulp and recycle them. These products are also non-biodegradable and therefore resist composting.

Water repellent packaging currently utilizes petroleum based liquid polymer coatings or polymer film laminates (including polyethylene or similar film laminates such as polyolefin, polyester, polyvinyl alcohol, polyvinyl acetate, polystyrene, polypropylene, and the like) which are recyclable after extensive treatment, All of these laminates require the installation of specialized repulping machinery that separates the pulp fibers from the coated or laminated films and/or is far more expensive in terms of operating costs and/or recycled pulp fiber yields. The action of separating the fiber from the film damages some fibers causing the fibers to be selected out of the recycled pulp and presented for reuse, while the separated film waste carries some of the fibers out of the repulpate when its adherence is not interrupted by the repulping process. Likewise, coatings and impregnating products made from or based on paraffin waxes and/or similar petroleum derivatives can only be repulped for recycling in specially configured repulping equipment that removes and separates the paraffin waxes. In the laminated film repulping process, the more intense physical and chemical requirements of this repulping process coupled with the lost fibers that become trapped in paraffin wax wastes, causes the recyclable repulped fiber levels to fall far below those of standard repulping processes. Moreover, boxes made from such products are not biodegradable and must be separated and deposited in separate landfill areas.

The poultry box industry has previously used wax to coat the boxes (EVA—poly (ethylene vinyl acetate) which takes a significantly long period of time to compost and leaves a chemical residue from those compounds. There appears to be little or no decomposition of higher molecular weight resin and EVA fractions.

In the prior art, a number of patents have attempted to address the above noted problems but have only moved incrementally forward in solving the customer's problems. U.S. Pat. No. 6,103,308 issued Aug. 15, 2000 is directed toward a paper and paperboard coating composition using vegetable oil triglyceride as a paper coating while U.S. Pat. No. 6,201,053 issued Mar. 13, 2001 is directed toward various triglycerides mixed with catalysts for use as a waterproofing agent on paper coating.

U.S. Pat. No. 6,846,573 issued Jan. 25, 2005 discloses the use of hydrogenated triglycerides having a melting point above 50° as a coating material for the surface of paper products to improve wet strength and moisture resistance in addition to being repulpable.

U.S. Pat. No. 7,413,111 issued Aug. 10, 2008 is directed toward a container for storing and shipping produce which is reinforced with at least one cross beam extending across the bottom wall of the container to form a bridge under loose product placed in the container to support at least a portion of the weight of the product and prevent sagging of the container bottom. The cross beam is positioned and held in place by engaging the ends of the cross beam in recesses formed by crushed areas on an inner surface of opposing side walls, or cut-outs in the side walls, and/or by flaps folded upwardly from the container bottom wall and to which the cross beam is attached.

U.S. Pat. No. 8,455,068 issued Jun. 4, 2013 discloses the combination of impregnation of the poultry boxes with hydrogenated triglyceride and covering the outer surface of the liners with a dimethyl or ethylene terephthalate (PET) resulting in corrugated poultry boxes which provided moisture resistance and were recyclable and repulpable. The boxes, however, were only able to obtain a 30 minute Cobb value of 20-30.

U.S. Pat. No. 5,752,648 issued May 19, 1998 is directed toward an eight sided poultry box formed of corrugated paperboard. The lower ends of each of the four corner panels are provided with folds, which extend from the peripheral corner portions of the box bottom toward the exterior surfaces of the corner panels. The folds function as abutments and restrict rotational movement of the corner panels about their longitudinal axes occasioned by compressional forces generated on the box ends during shipment and handling. This box is widely used in the industry but allows corner leakage which causes corner crushing and panel tearing when the boxes are stacked.

None of the noted references have provided a repulpable, recyclable corrugated box capable of holding iced products and being moisture resistant while maintaining crush and tear strength. All of these corrugated boxes are susceptible to corner leaks which spill out of the box chamber reducing box tear strength and increasing corner crushing. Typically, poultry boxes are stacked seven layers high with seven boxes forming each layer. The prior art boxes allow collection of moisture and have leakage at the corners causing stacked boxes to crush and tear with spillage of the contents at the corners which results in boxes of poultry and other foodstuffs to be rejected by the receiver of the goods and the end purchasers of the goods. The spillage also causes fluids to be discharged over the corrugated container which might present a health hazard or contaminate foodstuffs in other containers.

The present invention has been developed to solve these problems in the industry.

### SUMMARY OF THE INVENTION

The present invention is directed to a backed corrugated paper box product which has the outer paper liner or backer sheet surfaces coated with a copolymer styrene acrylic emulsion with the inner corrugated paper medium and liner sheets being impregnated with a hydrogenated triglyceride such as tallow or palm oil. The coated paper box is constructed with a reinforced end panel assembly, hand cut outs and covered corners ranging from about ⅝ inch to about 1⅜ inches to prevent leakage.

The present invention is easier to repulp and recycle without detriment to production equipment, processes, or manufactured product quality or performance.

It is an object of this invention to produce a paper box product which can be compacted, repulped and recycled.

It is another object of the invention to produce a poultry box which is biodegradable.

It is still another object of the invention to produce a poultry box which has superior moisture resistance and does not leak at the corners.

The invention will be better understood and objects other than those set forth above will become apparent when consideration is given to the following detailed description thereof. Such description makes reference to the annexed drawings wherein.

### BRIEF DESCRIPTION OF THE DRAWINGS

FIG. 1 is a perspective view of a prior art poultry box with top removed;

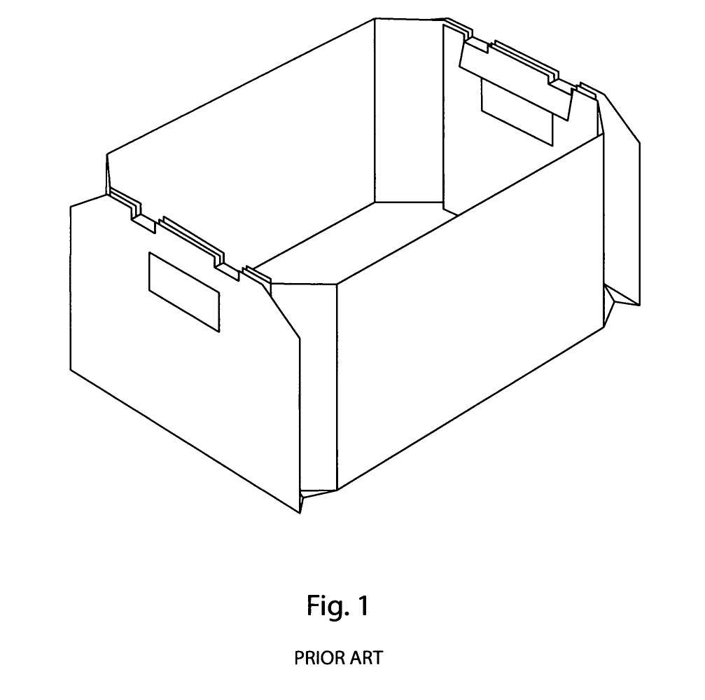

FIG. 2 is a perspective view of the inventive poultry box with top removed;

FIG. 2A is a perspective view of a standard top used with the inventive poultry box of FIG. 2;

FIG. 3 is a perspective view of the poultry box of FIG. 2 with an end panel assembly opened;

FIG. 4 is an enlarged partial view of end panel assembly and the bottom corner pinch seal tabs of the poultry box shown in FIG. 2;

FIG. 5 is a finished blank of the poultry box shown in FIG. 2;

FIG. 6 is a finished blank of another poultry box based on the poultry box shown in FIG. 2 with pinch corner tabs located 1⅜ inches and 1¼ inches from the end panel assembly fold line;

FIG. 7 is a finished blank of yet another poultry box based on the poultry box shown in FIG. 2 with pinch corner tabs located 1⅛ inches and 1 inch from the end panel assembly fold line;

FIG. 8 is another embodiment of a finished poultry box blank 43 7/16 inches in length by 33¼ inches in width with glued end panels and without a hinged panel flap.

FIG. 9 is an embodiment of the finished poultry box blank of FIG. 8, 42 1/16 inches in length by 31¾ inches in width with glued end panels and without a hinged panel flap.

FIG. 10 is an enlarged cross section of the corrugated blank used in the poultry boxes shown in FIGS. 2-9; and

FIG. 11 is a schematic of the corrugator used in making the poultry box of FIG. 2.

### DETAILED DESCRIPTION OF THE INVENTION

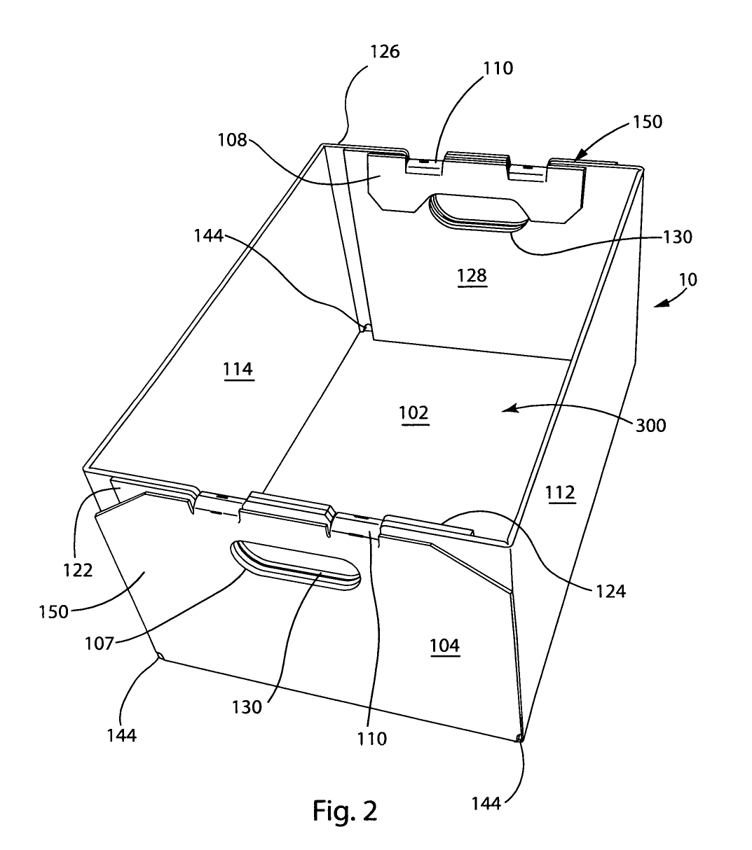

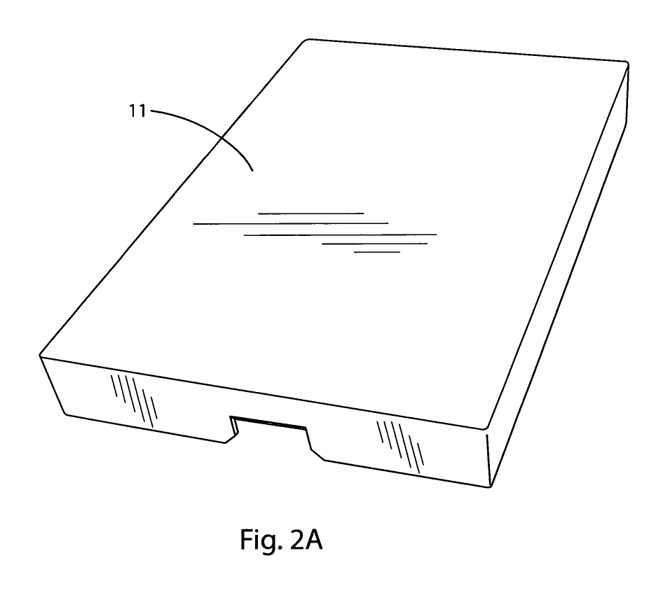

The preferred embodiment and best mode of the invention are shown in FIGS. 2 through 7 and 10. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

### Definitions

As used herein the following abbreviations and terms are understood to have the meanings as set forth:

The term “Triglyceride” includes both animal fats and vegetable oils and is derived from one or more of them. Animal fats include beef tallow, pork lard, poultry grease and fish oils. Vegetable oils include palm oil, soybean oil, peanut oil, olive oil, coconut oil and cottonseed oil.

The term “Paraffin” is a wax-like product derived from petroleum.

The terms “Paper” and “Paperboard” includes substrates and surfaces of cellulosic material.

It has been found that hydrogenated triglycerides and preferably lard or tallow triglycerides can be substituted for petroleum based paraffin waxes and wax compounds in the manufacturer of paper products. All of these application systems involve melted triglycerides held at temperatures in the range from around 125° F. to 170° F. which is either squeezed, rolled, cascaded, sprayed, or doctored onto the linerboard, paper, carton stock, or corrugated medium surface to impregnate the same.

The method and machinery or equipment for repulping and recycling scrap paper in the paper and paperboard or liner board industry is both an established and well known art, and the equipment required is standard and commonly installed at most mills incorporating recycled paper in their manufacturing feed stocks. Thus, those skilled in the paper making art are also knowledgeable in re-pulping and recycling.

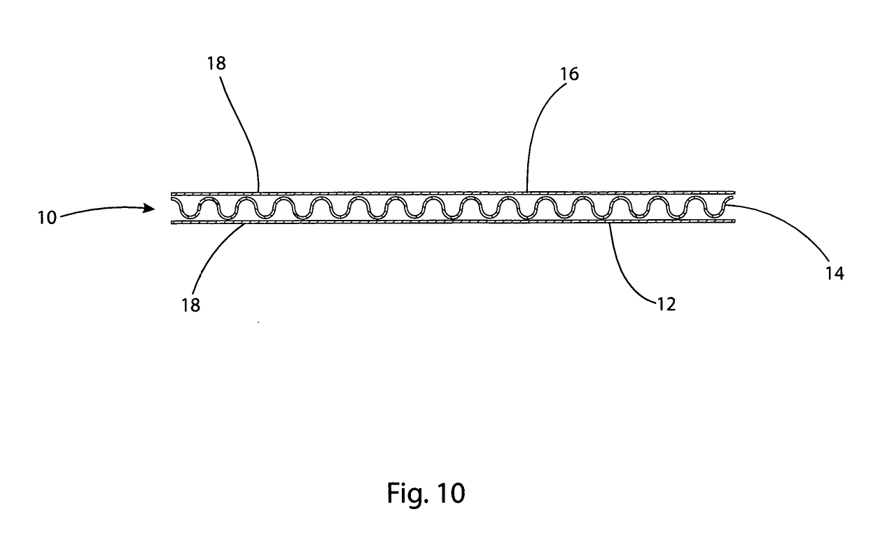

Poultry boxes are unique paper products that need to withstand water and poultry fluid. The present inventive poultry box is made of double backer corrugated board having a corrugated medium of 30 to 40 lb./1000 sq. ft. (MSF) paperboard of an “A”, “B”, “C”, “E” and “F” flute size (weight depends upon various external factors). The preferred flute size used in the invention is a “C” flute having 39+/−3 flutes per lineal foot with a flute thickness of 5/32 inch. A flat liner or backer board of Kraft paper (various grades) is glued to one side of the fluted medium with a starch based adhesive and a second flat liner or backer board of Kraft paper is adhered to the other side of the fluted medium with a starch based adhesive to form a backed corrugated board as seen in FIG. 10. The Kraft paperboard liner may be bleached white, coated white (white coat), mottled white or colored. As is well known in the art, the medium paper is humidified by means of high pressure steam which softens the paper fibers to facilitate the formation of the flute and consequent gluing. After formation of the board, this humidity is removed by drying in the dry-end. In the present invention, the newly formed corrugated liner board is heated from the bottom by hot plates and the adhesive holding components of the structure is cured.

The present repulpable inventive degradable poultry box 10, a cross section of which is seen in FIG. 10, is constructed with an inner Kraft paper liner or backer 12 impregnated with a hydrogenated triglyceride, preferably tallow at 2.5 lbs/MSF, a corrugated paper medium 14 impregnated with a hydrogenated triglyceride, preferably tallow when animal fats are used at 3.5 lbs/MSF and an outer Kraft paper liner or backer 16 which is also impregnated with tallow at 2.5 lbs/MSF. Other animal fats which can be used include pork lard, poultry grease and fish oils. Hydrogenated triglycerides which can be used in the invention are animal fats and vegetable oils. Vegetable oils include soybean oil, peanut oil, olive oil, palm oil, coconut oil and cottonseed oil with the preferred oil being palm oil. Hydrogenated triglycerides used in the impregnation are commercially available from C.J. Robinson Co. and Chemol Corporation.

After impregnation of the paper liners, both liners or backers 12 and 16 are coated on their outside surfaces with a coating 18 of a styrene acrylic co-polymer water based solution ranging from about 75% to about 95% by weight mixed or blended with hydrogenated triglyceride preferably in the nature of tallow ranging from about 5% to about 25% by weight to form an emulsified coating. A most preferred embodiment of the coating 18 is about 80% by weight styrene acrylic co-polymer solution and about 20% by weight hydrogenated triglyceride which is preferably in the form of tallow or palm oil. The coating emulsion is heated and mixed at the general time of application and heated to a temperature from about 160° F. to about 180° F., preferably at about 170° F.

The coating 18 is a water based high solid fluid solution (% by weight of the styrene acrylic co-polymer ranging from about 50% to about 55%) most preferably about 52% and has a pH ranging from about 8-9 with fully cured Tg of +7, a specific gravity of ranging from about 1.04 to about 1.6 and viscosity (cps) of about 400, a vapor density the same as water with 30 minute Cobb values of 10 or better. The coating is fast drying, recyclable, repulpable and is printable and glueable.

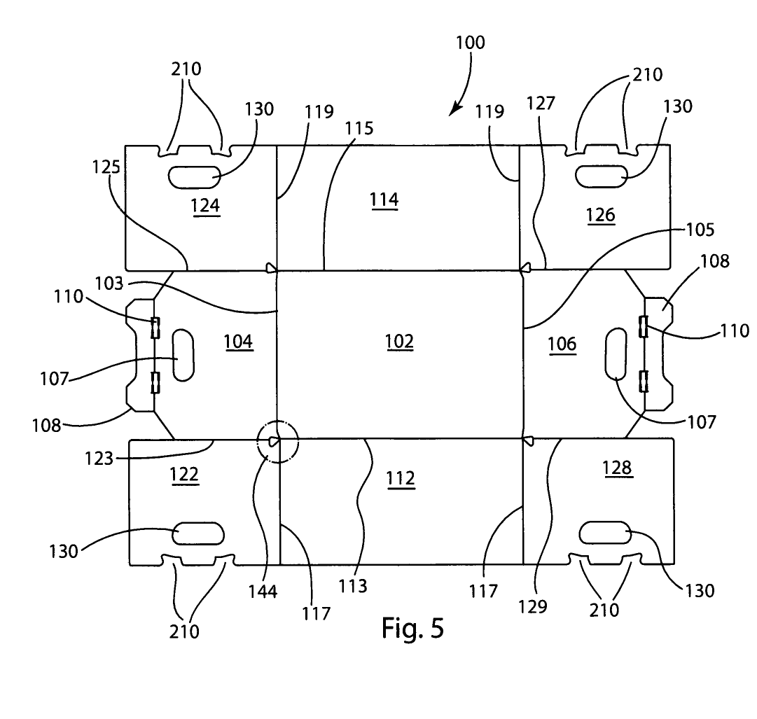

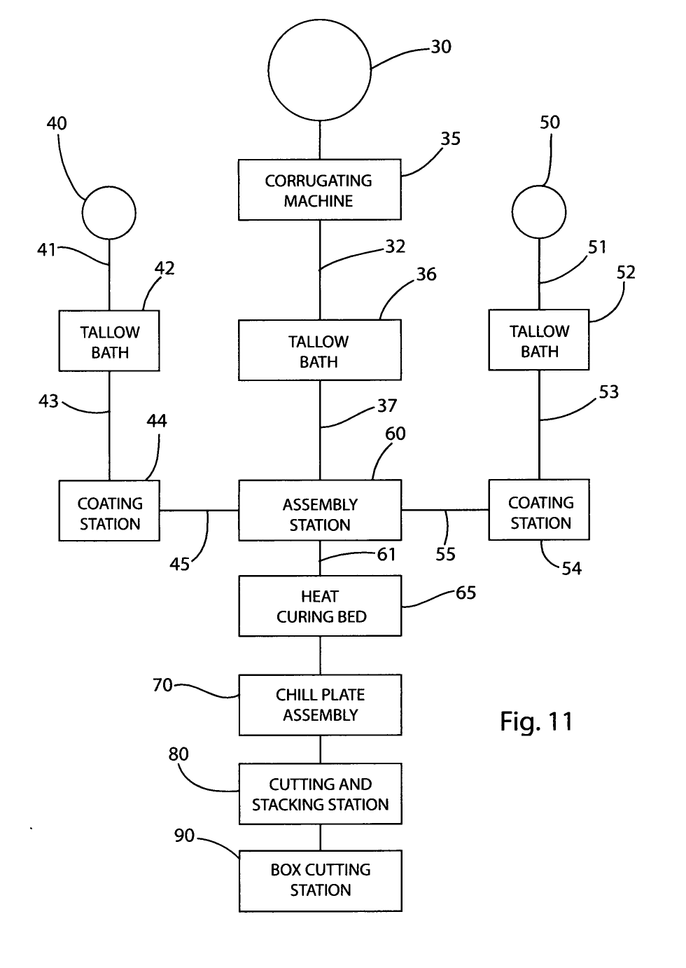

The term “tallow” as used herein is meant to also cover palm oil and other hydrogenated triglycerides. The present poultry box 10 is constructed using standard corrugated box making machinery as is well known in the art. As shown in FIG. 11, a roll 30 of the medium paper is positioned upstream of the corrugator. The paper is wetted and passed through a standard corrugating machine 35 and formed into a corrugated medium 32 having the desired flute size, preferably a “C” size. The corrugated medium 32 is transported downstream through a hydrogenated triglyceride bath, preferably, a tallow or palm oil bath 36 and associated rollers with the corrugated medium being impregnated with tallow at 2.5 to 3.5 lbs/MSF. The impregnated corrugated medium 37 is carried by belts to an assembly station 60 where the coated liner backers 45 and 55 formed of Kraft paper 40 and 50 as further described below are secured to the corrugated medium 37 to form a composite board or sheet 61. Two liner rolls of roll stock of Kraft paper 40 and 50 are removed from their respective rolls and the respective liner sheets 41 and 51 are transported by rollers (not shown) through separate hydrogenated triglyceride baths (preferably tallow baths) 42 and 52. Associated rollers apply tallow to the liner backer sheets 41 and 51 at 2.5 lbs/MSF impregnating the same. The now impregnated liner backer sheets 43 and 53 are then transported by rollers and coated at coating stations 44 and 54 on a single sheet surface side with the emulsion coating 18 heated to about 170° F. The emulsion coating which is preferably a styrene acrylic copolymer or a blend of the styrene acrylic copolymer and hydrogenated triglyceride can be placed on the backer sheet surface by rods, rollers, doctor blades or spraying as is well known in the art. The emulsion coating is translucent to milky white and is water based. The coated liner sheets 45 and 55 are then glued at a gluing station in the assembly station 60 to the corrugated medium 37 with a suitable adhesive as is well known in the art to form a coated corrugated composite board with an emulsified coating 18 on its top and bottom outside surfaces. The coated corrugated composite board 61 is then passed over a heat curing bed 65 to cure and set the adhesive or glue. The heat curing bed 65 is a series of hot plates and pressure rollers which applies light pressure and heat to cure the adhesive which is standard in the corrugated box making art and the glue cures very rapidly. The composite board is run through a chill plate assembly 70 which drops the corrugated temperature to 70° F. allowing the blanks to be cut and stacked without sticking. The cured composite corrugated board sheet 61 is then cut into individual blank sections in a cutting and stacking station 80 with known means stacking the individual flat sheets of composite corrugated board. If desired, air impact dryers can be used to dry the flat sheets. The individual composite corrugated blanks are stacked and dried for a day. The blanks are later placed in a standard box cutting station 90 which cuts and scores the composite poultry box blank 100 in a finished blank form as shown in FIGS. 5-9.

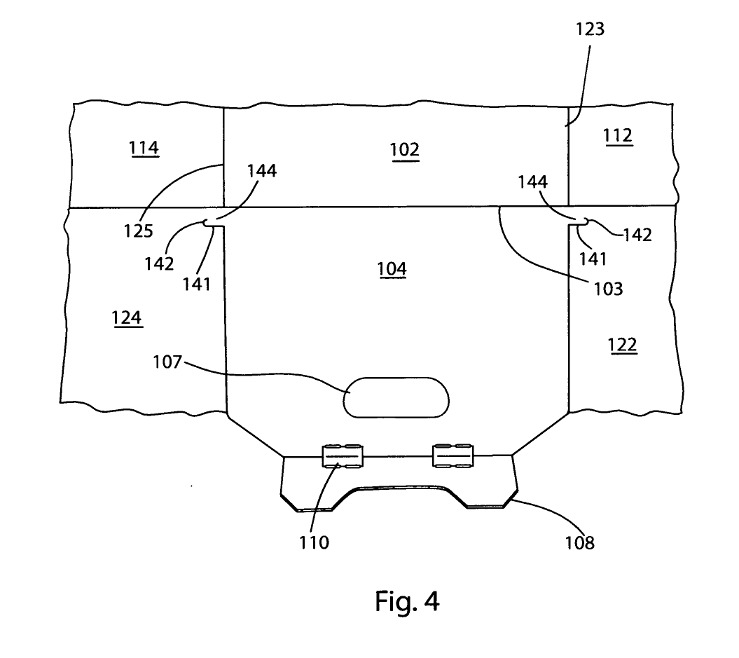

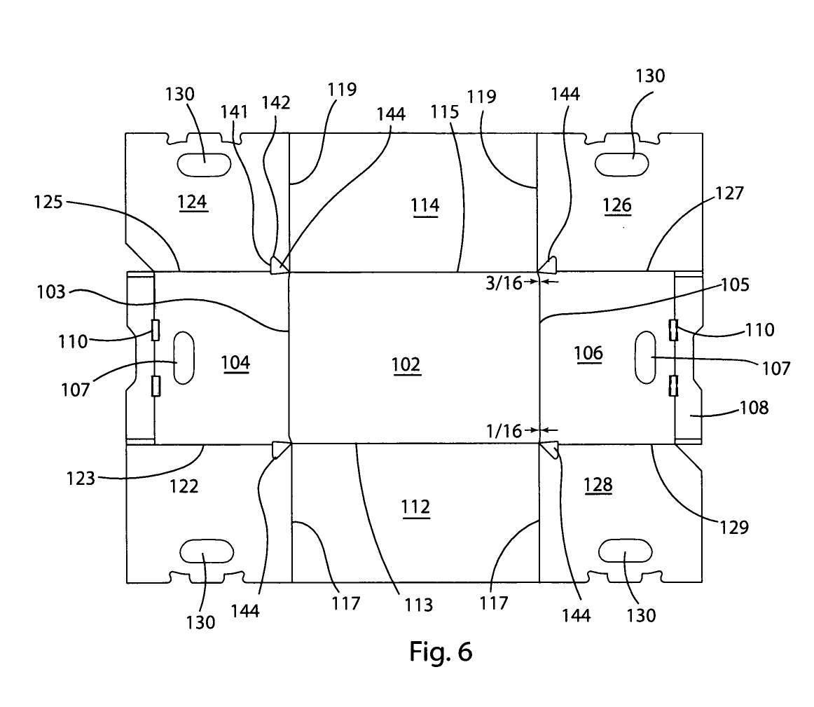

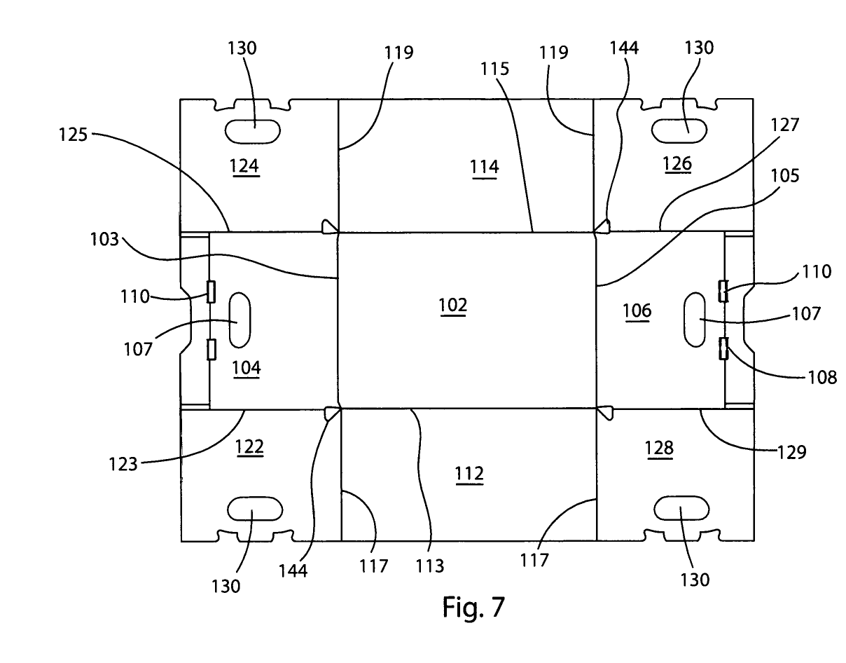

The box blank 100 as shown in FIGS. 5-7 is cut and scored in the box cutting station to form a bottom panel 102 with opposing integral end panels 104 and 106 being joined thereto at the fold lines 103 and 105. Each of the end panels 104 and 106 has a hand cutout 107 and a closing flap 108 mounted to each end panel 104 and 106 by a spaced plurality of hinges 110. Side wall panels 112 and 114 are positioned on opposite sides of bottom panel 102 and are integral thereto being joined along their respective fold lines 113 and 115 allowing the side panels 112 and 114 to be folded upward and positioned transverse to the plane of bottom panel 102. Each end surface of the side panels 112 and 114 is integral with the end of reinforcing panels 122, 128 and 124, 126 respectively and is joined to the reinforcing panels by fold lines 117 and 119. End reinforcing panels 122, 124 and 126, 128 are positioned on opposite sides of end panels 104 and 106, respectively. End reinforcing panels 122, 124 are separated from the outer end panel 104 by parallel cuts 123, 125 and end reinforcing panels 126 and 128 are positioned on opposite sides of outer end panel 106 and are separated from end panel 106 by parallel cuts 127 and 129. This allows the respective reinforcing panels to be separated from the outer end panels 104 and 106 and folded over each other with the outer end panel then being folded upward adjacent the respective reinforcing panels to form a 3 layer composite end panel assembly 150 so that cut outs 130 of the reinforcing end panels are aligned with cut outs 107 of the outer end panels. Cut lines 123, 125, 127 and 129 are cut down the sides of end panels 104 and 106 but do not engage or intersect the fold lines 103 and 105. The cut lines are ended about ⅝ inch to about ¾ inch from the fold lines 103 and 105 as shown in FIG. 5. In FIG. 6, the cut lines are ended about 1¼ inch to about 1⅜ inch from the fold lines 103 and 105 and in FIG. 7, the cut lines are ended about 1 inch to about 1⅛ inch from the fold lines 103, 117, 119 and 105, 117, 119. Cut lines 123, 125, 127 and 129 of the reinforcing end panels end with a transverse cut 141 extending from the end of each cut line inward into the body of the respective reinforcing end panels. The transverse cut 141 is substantially parallel to the fold lines 103 and 105 with each transverse cut having a distal rounded cut section 142 extending from the transverse cut 141 into the body of the reinforcing end panel. When the reinforcing end panels and outer end panel are folded inward they form an end panel assembly 150 perpendicular to the bottom panel 102. A corner pinch tab 144 is formed by a transverse cut 141 and distal cut 142 which intersects the transverse cut. The tab 144 is integral with the outer end panel and adjacent reinforcing end panel to form a pinched corner seal as best seen in the partial exploded blank end view of FIG. 4.

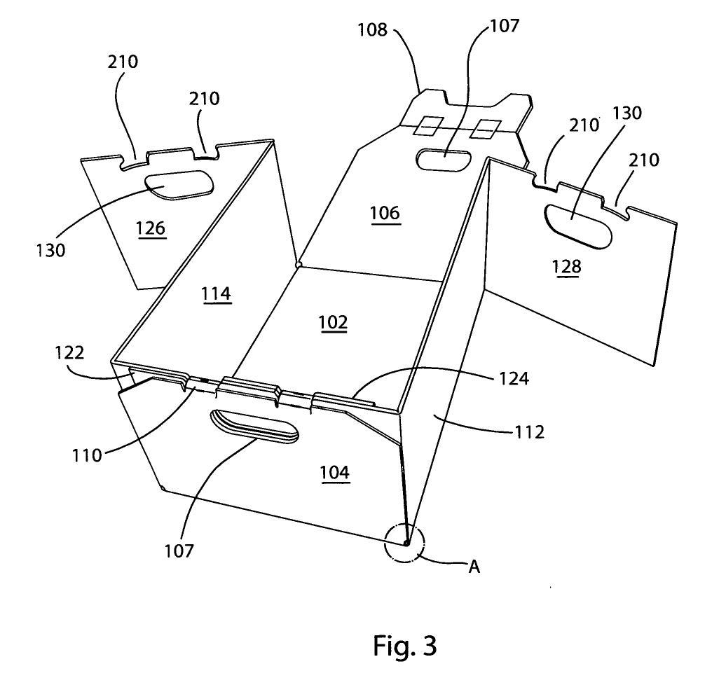

The pinched corner tab 144 ranges from ⅝ inch to about 1⅜ inch in length depending upon the length of transverse cut 141 from the bottom panel and the corner seal depth desired when the box is assembled. See FIGS. 3-9. It should be noted that fold lines 117 and 119 are offset from the end panel fold lines 103 and 105 from 1/16 inch to 3/16 inch as shown in the FIG. 6 so that the bottom panel 102 is slightly offset from the side panels 112 and 114 to form the raised pinch corner tabs 144. The pinch corner tabs 144 thus forms a seal for each corner of the box extending upward a predetermined distance preventing drainage of fluid at the corners which has leaked into the box chamber.

The box 10 when folded has the reinforcement panels folded inward parallel to each other with the end panels 104 and 106 being positioned on the outside of the box forming the exterior panel of the end panel assembly. As shown in FIG. 2, when the box 10 is assembled, the hinges 110 of the end panels 104 and 106 fold over the adjacent reinforcing end panels separated top cut outs 210 with the end panel flaps 108 extending downward into the box chamber 300 to hold reinforcing panels 122 and 124 in an aligned parallel position with end panel 104 and reinforcing panels 126 and 128 in an aligned parallel position with end panel 106. All four reinforcing panels 122, 124, 126 and 128 are provided with a hand cut outs 130 which align with the hand cut outs 107 of end panels 104 and 106 when the box is assembled. As shown in FIGS. 2 and 3, neither of the side free end edges of the reinforcing panels engages the opposite side panel or a plane taken across the surface of the opposite side panel. The box is provided with a standard folded lid or cover 11 which is well known in the art and is shown in FIG. 2A. FIGS. 5-7 show different dimensioned boxes. FIG. 5 is a box blank 42 1/16 inches in length and 31¾ inches in width forming a box 18 1/16 inches by 12¾ inches with a 11⅝ inch depth. FIG. 6 is a box blank 43 1/16 inches in length and 33¼ inches in width forming a box 18 1/16 inches by 12¾ inches with a 10¼ inch depth. FIG. 7 is a box blank 43 1/16 inches in length and 33¼ inches in width forming a box 18 1/16 inches by 12¾ inches with a 9 9/16 inch depth.

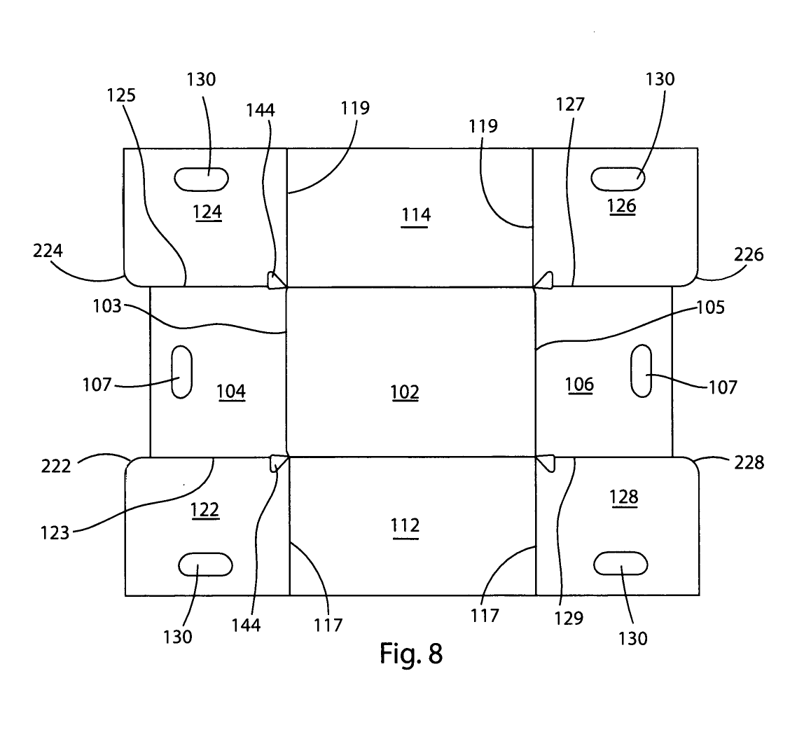

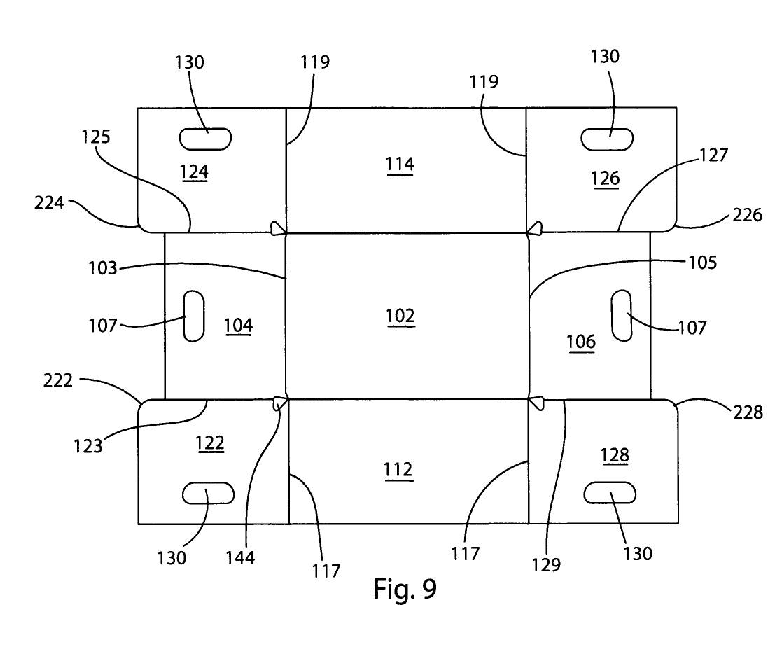

A second embodiment of the invention is shown in FIGS. 8 and 9 and is constructed and assembled identical to the preferred embodiment discussed above differing only in that there are no hinges 110 or closing flaps 108 on the outer end panels 104 and 106 and the reinforcing end panels do not have separated top cut outs 210 and have a rounded inward end corners 222, 224, 226 and 228 which are seated against bottom panel 102.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What is claimed is:

1. A repulpable moisture resistant corrugated box comprising a composite structure with a fluted medium, a top paper backing liner secured to one side of said fluted medium and a bottom paper backing liner secured to the other side of said fluted medium, with at least one of said paper backing liners and said fluted medium being impregnated with a hydrogenated triglyceride or a blend of hydrogenated triglycerides, said box comprising a bottom panel, side panels integral with said bottom panel and end panels assemblies integral with said bottom panel and said side panels, each said end panel assembly comprising an outer end panel and a plurality of reinforcing end panels adjacent to said outer end panel, said reinforcing end panels being integral to an adjacent side panel and said outer end panel at a bottom corner, each outer end panel and end reinforcing panel defining a cut out which is aligned with each other to present a single uniform cut out when assembled into a box, said reinforcing end panels being connected to said outer end panel by a corner tab formed by a cut adjacent each bottom corner of said outer end panel.

2. The repulpable moisture resistant corrugated box of claim 1 wherein at least one of said paper backing liners has an outer surface coated with an emulsified copolymer mixture of styrene acrylic to provide moisture resistance and wet strength to said paper product, said paper product being repulpable and recyclable.

3. The repulpable moisture resistant corrugated box of claim 2 wherein the emulsified coating is at least 75% by weight of styrene acrylic with the remainder by weight being hydrogenated triglyceride.

4. The repulpable moisture resistant corrugated box of claim 1 wherein the hydrogenated triglyceride is a hydrogenated vegetable oil selected from a group consisting of soybean oil, peanut oil, olive oil, palm oil, coconut oil and cottonseed oil.

5. The repulpable moisture resistant corrugated box of claim 1 wherein the hydrogenated triglyceride is an animal fat selected from a group consisting of beef tallow, pork lard, poultry grease, and fish oils.

6. The repulpable moisture resistant corrugated box of claim 3 wherein the emulsified coating is applied to the outer surfaces of said paper backing liners in a range of about 1.0 to about 2.0 lbs per thousand square feet of liner board surface.

7. The repulpable moisture resistant corrugated box of claim 1 wherein each reinforcing end panel defines a spaced cutout on a distal end and said outer end panel comprises a panel section with flap means which can be folded over said reinforcement end panel spaced cutout.

8. The repulpable moisture resistant corrugated box of claim 1 wherein said flap means is at least one hinge mounted as said panel section connected to a fold member.

9. The repulpable moisture resistant corrugated box of claim 8 wherein said lap means is a plurality of hinges mounted on said panel section connected to a fold member.

10. The repulpable moisture resistant corrugated box of claim 1 wherein said end reinforcement panels as offset from an end fold line defined by said bottom panel.

11. The repulpable moisture resistant corrugated box of claim 1 wherein each reinforcing end panel of each end panel assembly has at least one rounded corner.

12. The repulpable moisture resistant corrugated box of claim 10 wherein a tab cut is made in each reinforcing panel of said end panel assembly transverse to a side of said outer panel at a distance ranging from about ¼ inch to about 1⅜ inches from said bottom panel.

13. The repulpable moisture resistant corrugated box of claim 12 wherein each transverse cut has a rounded cut on its distal end.

14. The repulpable moisture resistant corrugated box of claim 1 wherein said end panel assembly comprises an outer end panel integral with and aligned with an end of said bottom panel, and reinforcing end panels positioned on each side of said outer end panel integral with adjacent side panels, said reinforcing end panels being substantially separated from said outer end panel by a plurality of parallel linear cuts which run to within a range of ¼ inch to 1⅜ inches from an end of said bottom panel.

15. A repulpable moisture resistant corrugated box comprising a composite structure having a fluted medium, a top paper backing liner secured to one side of said fluted medium and a bottom paper backing liner secured to the other side of said fluted medium, with at least one of said paper backing liners and said fluted medium being impregnated with a hydrogenated triglyceride and coated with a styrene acrylic co-polymer, said box comprising a bottom panel, side panels integral with said bottom panel and separated from said bottom panel by a fold line, end panels assemblies mounted on each end of said box to said bottom panel, each said end panel assembly comprising an outer panel integral to said bottom panel and separated from said bottom panel by a fold line, and a plurality of reinforcing end panels mounted adjacent to said outer end panel, each end reinforcing panel being separated from said outer end panel by a cut line which does not extend to said bottom panel, each end reinforcing panel being integral to but separated from an associated side panel by a fold line, a cut line transverse to and intersecting each of said reinforcing end panel cut line, said transverse cut line extending into said reinforcing panel and having a second cut leading away from said transverse cut line at its distal end to define a corner tab, said reinforcing end panels being connected to end panel by said corner tabs to seal corners of said box, said outer end panels and reinforcing panels each defining a cutout which is aligned into a single uniform cutout when the reinforcing panels are folded against the outer panel to form an end panel assembly.

16. The repulpable moisture resistant corrugated box of claim 15 wherein each transverse cut has a rounded cut on its distal end.

17. The repulpable moisture resistant corrugated box of claim 15 wherein said end panel assembly comprises an outer panel integral with and aligned with an end of said bottom panel, and reinforcing panels on each side of said center panel integral with said adjacent panels, said reinforcing panels being substantially separated from said outer panel by a plurality of parallel linear cuts which run to within a range of ¼ inch to 1⅜ inches from an end of said bottom panel.

18. The repulpable moisture resistant corrugated box of claim 15 wherein a tab cut is made from an edge of each reinforcing panel of said end panel assembly transverse to said outer end panel at a distance ranging from about ¼ inch to about 1⅜ inches from said bottom panel.

19. The repulpable moisture resistant corrugated box of claim 15 wherein each reinforcing end panel of each end panel assembly has at least one rounded corner.

20. A repulpable moisture resistant corrugated box comprising a composite structure having a fluted medium, a top paper backing liner secured to one side of said fluted medium and a bottom paper backing liner secured to the other side of said fluted medium, with at least one of said paper backing liners and said fluted medium being coated with a styrene acrylic co-polymer, said box comprising a bottom panel, side panels integral with said bottom panel and separated from said bottom panel by fold lines and end panels assemblies mounted on each end of said box, each said end panel assembly comprising an end outer panel integral to said bottom panel and separated by a fold line, and a plurality of reinforcing end panels mounted adjacent to said outer end panel, each end reinforcing panel being separated from said outer end panel by a cut line which does not extend to said bottom panel, each end reinforcing panel being integral to but separated from an associated side panel by a fold line, a tab cut transverse to each reinforcing panel cut line, said transverse tab cut extending into said reinforcing panel and having a second cut engaging said transverse cut and extending away from said transverse cut line at its distal end to define a corner tab when said box is assembled, said reinforcing end panels being connected to outer end panel by said corner tabs to seal the bottom corners of said box, said outer end panel and reinforcing end panels each defining a cutout which is aligned into a single uniform configured cutout when the reinforcing end panels are folded against the outer panel to form an end panel assembly, each reinforcing end panel defines a spaced cutout on a distal end and said outer end panel is provided with moveable flap means which can be folded over said reinforcement end panel spaced cutout.

21. The repulpable moisture resistant corrugated box of claim 20 wherein said flap means is at least one hinge member mounted to said outer end panel and a fold member, said reinforcing panels being substantially separated from said outer end panel by a plurality of parallel linear cuts which run to within a range of ¼ inch to 1⅜ inches from the end of said bottom panel.
